(19) United States
(12) Patent Application Publication
(10) Pub. No.: US 2020/0241542 A1
(43) Pub. Date: Jul. 30, 2020

(54) Vehicle Equipped with Accelerated Actor-Critic Reinforcement Learning and Method for Accelerating Actor-Critic Reinforcement Learning

(71) Applicant: Bayerische Motoren Werke Aktiengesellschaft, Muenchen (DE)

(72) Inventor: Jou-ching SUNG, San Jose, CA (US)

(21) Appl. No.: 16/257,839

(22) Filed: Jan. 25, 2019

(51) Int. Cl. G05D 1/02; G05D 1/00; G06N 3/04; G06N 3/08; B60W 40/09

(52) U.S. Cl. CPC G05D 1/0221; G05D 1/0088; G05D 2201/0213; G06N 3/08; B60W 40/09; G06N 3/0454

(57) ABSTRACT

An autonomous driving vehicle includes a body, a source of motive power, and a controller. The source of motive power is operatively coupled to the body. The controller is configured to control the source of motive power. The controller includes a storage module in which pre-collecting data is stored. The controller is pre-trained with the pre-collected data. The pre-training is carried out using behavioral cloning and/or offline TD learning, before the autonomous driving vehicle enters an operational environment. The controller is further trained, after the pre-training, using an actor-critic reinforcement learning algorithm to fine-tune and thereby improve the final agent.

### BACKGROUND

The embodiments of the present invention are directed to an autonomous driving vehicle that is equipped with an accelerated, actor-critic reinforcement learning agent and to a method for accelerating actor-critic reinforcement learning.

Existing methods for reinforcement learning, using actor-critic networks, rely on standard reinforcement learning algorithms. When using standard reinforcement algorithms, however, the learning agent initially takes random actions in an environment.

In the case of autonomous vehicles, taking random actions can be very dangerous, particularly when the environment involves driving in the real world. Additionally, standard reinforcement learning algorithms can be very costly to train, given that if the environment involves autonomous driving in the real world, creating a suitable computer simulation can take a long time to develop and run.

### SUMMARY OF THE INVENTION

For at least the foregoing reasons, there exists a need for an autonomous driving vehicle that is equipped with an accelerated, actor-critic reinforcement learning agent, and for a method to accelerate actor-critic reinforcement learning. And, in particular, for an autonomous driving vehicle and for a method for accelerating actor-critic reinforcement learning, which are both safer and more cost effective to operate and implement than existing vehicles and methods. As used herein the term “agent” means the entity that is interacting with the environment, and the term “reinforcement learning agent” means both the actor and the critic, which interact with the environment.

These and other objectives are achieved by an inventive autonomous driving vehicle that includes a body, a source of motive power and a controller. The source of motive power is operatively coupled to the body. The controller is configured to control the source of motive power. The controller includes a storage module in which pre-collecting data is stored. Notably, the controller is pre-trained with the pre-collected data. The pre-training may be carried out using behavioral cloning and offline temporal difference (TD) learning, before the autonomous driving vehicle enters an operational environment. The controller may be further trained, after the pre-training, using an actor-critic reinforcement learning algorithm to fine-tune and improve the final agent/controller. Further, for pre-training and training a reinforcement learning agent, an arbitrary range of variables can be controlled, such as steering angle/torque, throttle, brake, lane change decisions, minimum distance to maintain to the vehicle in front, etc.

The above-referenced objectives are also achieved by an inventive method for learning and/or reinforcement including pre-collecting data. Notably, the method also includes pre-training an actor and critic with the pre-collected data. The pre-training may be carried out using behavioral cloning and offline TD learning, and before the actor enters an operational environment. And, after the pre-training, the method may also include using an actor-critic reinforcement learning algorithm to fine-tune and improve the final agent.

With, inter alia, the above configuration, in the inventive autonomous driving vehicle and in the inventive method the actor can be pre-trained using behavioral cloning with highly reliable data collected from professional drivers, and with data that is pre-collected while driving in real world conditions. Further, the critic can be pre-trained using stochastic gradient descent, to thereby minimize temporal difference error, in a supervised learning setting. Moreover, the pre-training step for the actor and critic networks can be carried out without any interaction with the environment, thereby greatly reducing danger to others in a particular driving environment.

Further, in the inventive autonomous driving vehicle and in the inventive method, after the pre-training has been conducted, neural networks may be used to execute actor-critic reinforcement learning algorithms, such as A3C or PPO. Notably, since the actor and critic networks were pre-trained with expert demonstration data, the reinforcement learning agent will more quickly learn the optimal behavior, than in vehicles and methods.

Other objects, advantages, and novel features of the present invention will become apparent from the following detailed description of one or more preferred embodiments, when considered together with the accompanying drawings, in which:

### BRIEF DESCRIPTION OF THE DRAWINGS

FIG. 1 is a diagrammatic depiction of the inventive autonomous driving vehicle; and

FIG. 2 is a flow chart that outlines the steps of the inventive method.

### DETAILED DESCRIPTION OF THE DRAWINGS

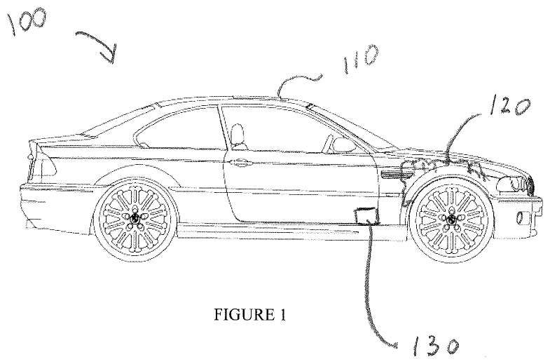

FIG. 1 depicts the inventive autonomous driving vehicle 100. As shown in FIG. 1, the inventive autonomous driving vehicle 100 includes a body 110, a source of motive power 120, and a controller 130. The source of motive power 120 is operatively coupled to the body 110. In one embodiment, the source of motive power 120 may be an internal combustion engine. The inventive autonomous driving vehicle, however, need not be limited to such configuration. In fact, in other embodiments the source of motive power 120 may be one or more electric motors, while in other embodiments the source of motive power 120 may be hybrid arrangement that combines an internal combustion engine with one or more electric motors.

As previously noted, the inventive autonomous driving vehicle 100 also includes a controller 130. The controller 130 is configured to control the source of motive power 120. Further, the controller 130 includes a storage module (not shown) in which pre-collected data is stored. In one embodiment, the storage module may be Random Access Memory. The inventive autonomous driving vehicle, however, need not be limited to such configuration, given that in other embodiments the storage module may be any device that is capable of storing information, as may occur to those having ordinary skill in the art.

Notably, the controller 130 is pre-trained with the pre-collected data, and the pre-training is carried out using behavioral cloning and offline TD learning, before the autonomous driving vehicle 100 enters an operational environment. Moreover, the controller 130 is further trained, after the pre-training, using an actor-critic reinforcement learning algorithm to fine-tune and improve the final agent. The details of the pre-training will now be discussed in detail with reference to the inventive method.

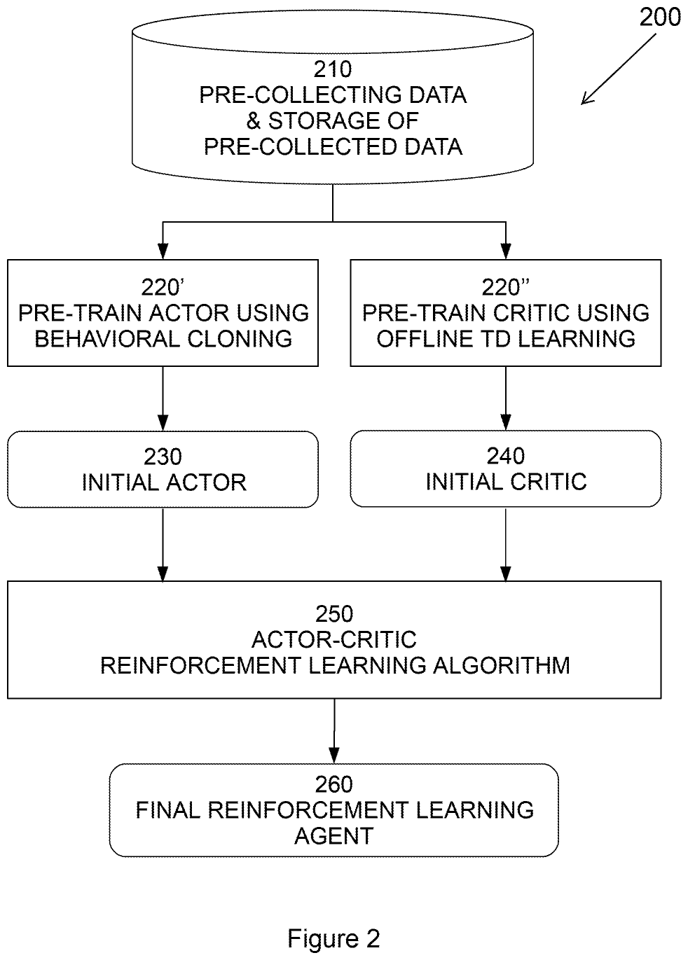

With reference to FIG. 2, the inventive method 200 for learning and/or reinforcement learning includes a first step of pre-collecting data 210. In one embodiment, the pre-collected data itself may be expert demonstrations. For instance, in one embodiment, the expert demonstration may consist of a professional driver that is engaged in the act of driving. The data may be collected contemporaneously, that is, while the professional driver drives the vehicle, or may be collected after the driver has finished driving the vehicle. Further, the act of driving may take place in a real world driving environment that is either open to other drivers, or in a controlled environment in which only the professional driver drives. The inventive method, however, need not be limited to such configuration. In fact, in other embodiments the pre-collected data may be data obtained from computer simulations, or data collected from any other sources as may occur to those having ordinary skill in the art. Notably, the term pre-collecting or pre-collected means that the act of collecting of the data takes place before the data is to be used to train a given actor, such as an autonomous driving vehicle.

As shown in FIG. 2, after the pre-collecting of data 210 has taken place, the method then includes a further step of pre-training an actor with the pre-collected data 220′. Notably, the pre-training step 220′ is carried out using behavioral cloning, and before the actor enters an operational environment.

As used herein, the term behavioral cloning means training an actor to imitate expert actions in given situations, such as those in autonomous driving. The actor may be a neural network, but need not be limited to such configuration. As used herein, the term “behavioral cloning” is a supervised machine learning problem, where the training dataset consists of expert demonstrations. Each expert demonstration consists of the expert's observations and the action(s) the expert took. A simple example of an observation could be an image from a forward-facing camera mounted on an autonomous test vehicle, and the action may be the steering wheel angle of the vehicle. Behavioral cloning, however, need not be limited to this example setup. The actor is then trained using supervised learning to output similar actions to the expert given similar observations, i.e., the actor is trained to imitate the expert. Some of the benefits of using behavioral cloning include, for example, that (1) the agent need not interact with the (potentially costly and/or dangerous) environment in order to learn expert behavior, and (2) the agent can be trained using standard supervised machine learning techniques.

As used herein, the term “neural network” means a type of machine learning algorithm which can learn an approximation of an arbitrary mathematical function. Neural network algorithms are inspired by the function of the biological brain. The term “deep learning” refers to a type of neural network algorithm. Further, specific terms can describe the architecture of a neural network, such as but not limited to: “convolutional neural network” (CNN), “recurrent neural network” (RNN), and “multi-layer perceptron” (MLP). Further technical details of neural networks can be found in the textbook “Deep Learning” by Goodfellow et al.

As noted above, the pre-training step 220′ is carried out before the actor enters an operational environment. As used herein, the term actor means the actor component in actor-critic reinforcement learning algorithms, such as, but not limited to: advantage actor critic (A2C), asynchronous advantage actor critic (A3C), proximal policy optimization (PPO), and deep deterministic policy gradients (DDPG). The actor consists of a learned function which maps the agent's observations to actions, also known as the “policy” function. In other words, the actor decides which action(s) the agent takes. In one embodiment, the operational environment may be road. The inventive method, however, need not be limited to such configuration, in fact in other embodiments the operational environment may be a track, or any other location or facility in which a vehicle is capable of operating, as may occur to those having ordinary skill in the art. Since in the inventive method the pre-training step 220′ is carried out before the actor enters an operational environment, the pre-training step may be carried out without any interaction with the environment, thereby greatly reducing risks of collisions, damage, and/or injuries.

As shown in FIG. 2, after the pre-training step 220′, the inventive method 220 includes a step of training an initial actor 230 and then using an actor-critic reinforcement learning algorithm 250. That is, in accordance with the inventive method 200, once the actor has been pre-trained in step 220′, the learning is subsequently reinforced in order to ensure that the actor has retained the data learned, and thereby ensure that the actor will be able to replicate the behavior learned with high fidelity. In addition, in the actor-critic reinforcement learning step 250, the actor is allowed to interact with the environment on its own, which will allow the reinforcement learning agent to learn how to handle new situations not seen in the expert demonstration data used in the pre-training step 220′, thereby fine-tuning and improving the performance of the final agent.

As shown in FIG. 2, in the inventive method 200, the pre-training step may also include pre-training a critic with the pre-collected data 220″. As used herein, the term critic means a component in actor-critic reinforcement learning algorithms, such as, but not limited to: advantage actor critic (A2C), asynchronous advantage actor critic (A3C), proximal policy optimization (PPO), and deep deterministic policy gradients (DDPG). The critic does not directly output the action(s). Rather, the main role of the critic is to aid in the reinforcement learning step 250. In actor-critic reinforcement learning algorithms, the critic effectively provides a reference/baseline to guide the actor's learning process. The critic can be a neural network, but need not be limited to such configuration. The pre-training of the critic in 220″ gives the critic a strong starting point for the reinforcement learning process in step 250. The critic is trained using TD learning. In the pre-training step 220″, the critic is trained using offline TD learning. As used herein, the term “offline” means that in step 220″ there is no interaction with the environment. In essence, offline TD learning is a supervised learning procedure in which the critic learns to minimize the temporal difference error based on the expert demonstration data. In contrast thereto, in step 250 the critic is trained using online TD learning. As used herein, the term “online” refers to the fact that the reinforcement learning agent (of which the critic is a component) is interacting with the environment, and the temporal difference error is minimized based on data collected from the reinforcement learning agent itself interacting with the environment.

In one embodiment, the actor may be a neural network. The inventive method, however, need not be limited to such configuration. In fact, in other embodiments the neural network may be part of a vehicle, and the vehicle may be a conventional vehicle, or an autonomous driving vehicle.

Although the term vehicle may be interpreted to mean an automobile, the inventive method need not be limited in application exclusively to a vehicle, or even to automobiles. In fact, in other embodiments, the inventive method may be applied to other means of transportation such as busses, trains, airplanes, or any other means of transportation as may occur to those having ordinary skill in the art.

In fact, the inventive method may not need to be limited to means of transportation. For instance, in other embodiments the method may be implemented to robots, or to any autonomous or even semi-autonomous moving body as may occur to those having ordinary skill in the art.

As shown in FIG. 2, in the inventive method 200, the pre-training of the critic 220″ may be carried out using offline TD learning. As used herein, the term offline TD learning means offline temporal difference learning. The critic may be a neural network. Using the expert demonstration data as the “ground truth,” one would run a supervised learning algorithm to train the critic to minimize the temporal difference error between the critic's predictions and the state value or state-action value derived from the expert demonstration data. As mentioned previously, the term “offline” refers to the fact that no interaction with the environment is required.

That is, if the pre-training is carried out offline, pre-training of the actor 220′ can only be done with behavioral cloning (i.e., not interacting with the environment). Although one can pre-train the actor using “Generative Adversarial Imitation Learning (GAIL),” GAIL requires interaction with the environment, which loses the benefit of learning without environment interaction. Pre-training of the critic can only done with offline TD learning.

Further, in the inventive method 200, the actor-critic reinforcement learning algorithm 250 may use deterministic policy gradient algorithms. As used herein, the term deterministic policy gradient algorithms means algorithms based on the deterministic policy gradient theorem, as described, for example, in “Deterministic Policy Gradient Algorithms” by Silver et al. In a deterministic policy gradient algorithm, the policy/actor outputs a deterministic action. In contrast, in stochastic policy gradient algorithms, the policy outputs a probability distribution over all possible actions, and the ultimate action the agent takes is sampled from this probability distribution. One example of a deterministic policy gradient algorithm is deep deterministic policy gradients (DDPG), a widely used algorithm in the reinforcement learning community. Relative to stochastic policy gradient algorithms, deterministic policy gradient algorithms are more sample efficient. That is, deterministic policy gradient algorithms require fewer interactions with the environment in step 250, to converge to a final trained agent. Deterministic policy gradients, however, are limited to the continuous action space-cannot handle uses cases where the action space is discrete. An example of a continuous action space is control of the steering wheel angle: one can specify 0 degrees, −32.5 degrees, 12.34 degrees, etc. An example of a discrete action space is a lane change decision: left lane change, right lane change, or stay in lane.

The inventive method, however, need not be limited to such configuration. In fact, in other embodiments the actor-critic reinforcement learning algorithm 250 may use stochastic policy gradient algorithms. As used herein the term stochastic policy gradient algorithm means algorithms based on the policy gradient theorem as outlined in the textbook “Reinforcement Learning: An Introduction”, 2^{nd} edition, by Sutton and Barto, in the chapter titled “Policy Gradient Methods.” In contrast to deterministic policy gradient algorithms, stochastic policy gradient algorithms output a probability distribution over all possible actions, and the action the reinforcement learning agent ultimately takes is sampled from this probability distribution. Examples of such algorithms include, but are not limited to: A2C, A3C, and PPO. Even though stochastic policy gradient algorithms are generally less sample efficient than deterministic policy gradient algorithms, an advantage of stochastic policy gradient algorithms is that these algorithms can support both continuous and discrete action spaces. For a given application, one with ordinary skill in the art would experiment with different stochastic and deterministic policy gradient algorithms to determine the optimal algorithm to use.

Moreover, the stochastic policy gradient algorithms may be one or more options. For instance, in one embodiment the stochastic policy gradient algorithm may be A3C. As used herein, the term A3C means asynchronous advantage actor critic, as described in “Asynchronous Methods for Deep Reinforcement Learning” by Mnih et al. The inventive method, however, need not be limited to such configuration. In fact in other embodiments the stochastic policy gradient may be A2C, PPO, or any other stochastic policy gradient algorithm that may occur to those having ordinary skill in the art. As used herein the term A2C means advantage actor critic, which is the A3C algorithm without the asynchronous functionality. Compared to A3C, A2C scales better in a multi-GPU reinforcement learning hardware compute setup. The asynchronous functionality in A3C was designed for a multi-CPU reinforcement learning hardware compute setup. As used herein the term PPO means proximal policy optimization, as described in “Proximal Policy Optimization Algorithms” by Schulman et al. Compared to A2C, PPO exhibits more stable learning behavior in the reinforcement learning step 250, and has the potential to achieve higher performance overall.

As was previously noted, in the step of pre-collecting of the data 210, the data may be collected from a professional driver, and the data may be recorded while the driver is engaged in real-world driving. The inventive method, however, need not be limited to such configuration. In fact, in other embodiments the collected data may be collected after the professional driver has finished driving, or may be collected from sources other than a professional driver, such as from computer simulations.

As shown in FIG. 2, the pre-training of the critic 220″ and the pre-training of the actor 220′ may be carried out separately. The inventive method, however, need not be limited to such configuration. For instance, in other embodiments (not shown) the pre-training of the critic 220″ and the pre-training of the actor 220′ may be carried together and/or concurrently.

Further, as shown in FIG. 2, the pre-training of the actor 220′ and the pre-training of the critic 220″ respectively yield an initial actor 230 and an initial critic 240. As used herein the terms initial actor 230 means the actor that has been trained using behavioral cloning based on expert demonstration data. The actor may be a neural network. The initial actor may be able to reproduce the expert actions in situations seen in the expert demonstration data. The initial actor is not a perfect expert, since in situations not seen in the expert demonstration data, the initial actor may struggle to generalize/interpolate to the optimal action. However, the initial (pre-trained) actor 230 will perform significantly better than a non-pre-trained/random actor (e.g., a randomly initialized neural network), thus helping to accelerate the subsequent reinforcement learning process 250.

As used herein the term initial critic 240 means the critic that has been trained using offline TD learning on the expert demonstration data. The critic may be a neural network. In essence, the critic learns the expected cumulative reward, as defined by the problem statement in a given situation. The main value of the (pre-trained) initial critic 240 is to help in accelerating the reinforcement learning process 250. Compared to a non-pre-trained initial critic (e.g., a randomly initialized neural network), the pre-trained initial critic 240 will have a significantly better estimate of the expected cumulative reward, thus aiding in accelerating the reinforcement learning process 250.

Moreover, as shown in FIG. 2, the initial actor 230 and the initial critic 240 are both used by the actor-critic reinforcement learning algorithm 250 to fine-tune, and thereby improve the final agent 260. The inventive method, however, need not be limited to such configuration. For instance, in other embodiments only the initial actor 230 or the initial critic 240 may be used by the actor-critic reinforcement learning algorithm 250 to fine-tune and thereby improve the final agent 260.

With the above discussed configuration, in the inventive method 200 the actor can be pre-trained using highly reliable data collected from professional drivers, data that is pre-collected while driving in real world conditions. Further, the actor can be pre-trained using behavioral cloning. Moreover, the pre-training step for the actor and critic networks can be carried out without any interaction with the environment, thereby greatly reducing danger to others in a particular driving environment. Further, since the actor and critic networks were pre-trained with expert demonstration data, the reinforcement learning agent will more quickly learn the optimal behavior than in existing art.

The foregoing disclosure has been set forth merely to illustrate the embodiments of the invention, and as such, it is not intended to be limiting. Since modifications of the disclosed embodiments incorporating the spirit and substance of the invention may occur to those having ordinary skill in the art, the invention should be construed to include everything within the scope of the appended claims, as well as equivalents thereof.

What is claimed is:

1. An autonomous driving vehicle comprising:
a body;
a source of motive power operatively coupled to the body; and
a controller configured to control the source of motive power, wherein
the controller includes a storage module in which pre-collecting data is stored;
the controller is pre-trained with the pre-collected data, the pre-training being carried out using behavioral cloning and/or offline TD learning, before the autonomous driving vehicle enters an operational environment, and
the controller is further trained, after the pre-training, using an actor-critic reinforcement learning algorithm to effect final reinforcement.

2. A method for learning and/or reinforcement, the method comprising the acts of:
pre-collecting data;
pre-training an actor with the pre-collected data, the pre-training being carried out using behavioral cloning and/or offline TD learning, and before the actor enters an operational environment; and
after the pre-training, using an actor-critic reinforcement learning algorithm to effect final reinforcement.

3. The method according to claim 2, wherein the pre-training also includes pre-training a critic with the pre-collected data.

4. The method according to claim 2, wherein the actor is a neural network.

5. The method according to claim 2, wherein the critic is a neural network.

6. The method according to claim 4, wherein the neural network is part of a vehicle.

7. The method according to claim 6, wherein the vehicle is an autonomous driving vehicle.

8. The method according to claim 3, wherein the pre-training of the critic is carried out using offline TD learning.

9. The method according to claim 3, wherein for the acts of pre-collecting data, pre-training, and reinforcement learning after pre-training, an arbitrary range of variables are controlled, including a steering angle/torque, a throttle position, a brake, lane change decisions, and a minimum distance to maintain with regarding to a preceding vehicle.

10. The method according to claim 2, wherein the actor-critic reinforcement learning algorithm uses deterministic policy gradient algorithms.

11. The method according to claim 2, wherein the actor-critic reinforcement learning algorithm uses stochastic policy gradients.

12. The method according to claim 2, wherein the pre-collected data is data collected from a professional driver taken while real-world driving.

13. The method according to claim 11, wherein the stochastic policy gradients are selected from the groups consisting of at least A3C, A2C, and PPO.

14. The method according to claim 3, wherein the pre-training of the critic and the pre-training of the actor are carried out separately.

15. The method according to claim 4, wherein the pre-training of the actor and the pre-training of the critic respectively yield an initial actor and an initial critic, and the initial actor and the initial critic are both used by the actor-critic reinforcement learning algorithm to fine-tune and thereby improve the final agent.

16. The method according to claim 8, wherein during the actor-critic reinforcement learning the critic is trained using online TD learning.
